(19) United States
(12) Patent Application Publication
(10) Pub. No.: US 2010/0053990 A1
(43) Pub. Date: Mar. 4, 2010

(54) ILLUMINATING GLASS COMPLEX

(75) Inventors: Cedric Brochier, Lyon (FR); Emmanuel Deflin, Brindas (FR)

Correspondence Address: MARJAMA MULDOON BLASIAK & SULLIVAN LLP, 250 SOUTH CLINTON STREET, SUITE 300, SYRACUSE, NY, 13202, US

(73) Assignee: Brochier Technologies, Villeurbanne (FR)

(21) Appl. No.: 12/515,832

(22) PCT Filed: Nov. 22, 2007
(86) PCT No.: PCT/FR07/52382

§ 371 Date: May 21, 2009

(30) Foreign Application Priority Data
Nov. 22, 2006 (FR) 0655049

(51) Int. Cl. G02B 6/44

(52) U.S. Cl. 362/556

(57) ABSTRACT

Illuminating glass complex characterized in that it comprises a light source consisting of a textile web containing optical fibres arranged in a warp and/or a weft associated with binding yarns in a warp and weft, said optical fibres being capable of emitting light laterally.

### CROSS REFERENCE TO RELATED APPLICATIONS

This application is a National Stage filing under 35 U.S. C. §371 of PCT Application No. PCT/FR2007/052382, filed Nov. 22, 2007. This application also claims the benefit of French Application No. 0655049, filed Nov. 22, 2006. The entirety of both applications is incorporated herein by reference.

The invention relates to the field of the illumination of a transparent or semi-transparent structure.

The invention is targeted more particularly at the type and mode of integration of the light source within the illuminating glass complex comprising at least two glass layers.

### BACKGROUND OF THE INVENTION

In general terms, illuminating complexes consisting of a transparent structure may come in various forms and generate diffuse or localized illuminations over their entire surface.

Illuminating complexes that provide light over their entire surface comprise light sources provided on the selvage of a translucent glass or poly methyl methacrylate (PMMA) plate. These plates include on one of their faces an etched pattern that enables sharp edges to be generated capable of deflecting the light in a given direction.

Such complexes are used particularly to backlight different supports and particularly negatives produced on a transparent sheet such as those used for X-ray plates. Light sources are arranged on the periphery of the etched plate, and enable light to be emitted inside the space defined by the plate.

However, such a complex has unsightly visible cuts which are therefore detrimental to the homogeneity of the light source. These cuts also remain visible when the complex is not illuminated, which means that the light source cannot be rendered totally invisible inside the illuminating complex.

According to another embodiment, illuminating complexes are also known that are added to the surface of a transparent plate to form an illuminating glass complex with localized illumination. In this event, light-emitting diodes (LED) are placed between two glass plates. Furthermore, a transparent electronic circuit is also provided between the two glass plates to supply electrical power to the different light-emitting diodes.

However, an illuminating complex of this kind does not allow diffuse illumination of the vitreous surface. Moreover, the cost of manufacturing is appreciably high since each localized source has to be placed manually and independently in a particular area of the vitreous surface.

The purpose of the invention is thus to implement a diffuse illumination of a transparent or translucent glass plate, this being able to be totally invisible inside the space defined by the plate.

Furthermore, another objective of the invention is to implement homogeneous illumination with greater illuminating power than existing products.

Illuminating complexes are also known that are formed by a textile comprising optical fibres capable of transmitting light laterally, said textile being associated with a layer of epoxy resin for diffusing the light. An illuminating complex of this kind, as particularly described in the document U.S. Pat. No. 5,021,928, has however many drawbacks.

Indeed, the heat and flame resistance of such a complex is not optimum or incompatible with the transparency of the illuminating complex. Thus, even if there are some resins that are adapted to be fire resistant, they are not perfectly transparent.

Moreover, manufacturing this type of illuminating complex requires a manufacturing method that is very long to implement, and more particularly if it is applied to both faces of the textile.

A third objective of the invention is therefore to achieve an illuminating complex that is both heat and flame resistant while being completely transparent. Lastly the manufacturing method thereof must be straightforward and quick to implement.

### SUMMARY OF THE INVENTION

The invention therefore relates to an illuminating complex that comprises two glass layers that have a transparent or translucent illuminating surface.

According to the invention, it is characterized in that it comprises a light source consisting of a textile web containing optical fibres arranged in a warp and/or weft and associated with binding yarns in a warp and weft. Such optical fibres are capable of emitting light laterally. Furthermore, the textile web is embedded between the two layers.

In other words, the textile web comprises optical fibres that not only allow light to be conveyed inside their structure, but also allow the light to be emitted laterally inside the illuminating glass complex capable of illuminating the surface thereof defined by the complex in a diffuse way. An illuminating textile web of this kind may be implemented in various ways, and in particular by conducting an invasive attack on the optical fibre cladding.

Said attack then generates alterations which can be obtained for example by a method of sandblasting the textile web, a chemical attack or by using a light beam of very great intensity scanning the surface of the textile web. The textile web can be treated in this way over its entire surface to make the glass complex fully illuminating. The treatment can also be localized and describe a particular pattern to implement a signalling system, display a message or an image.

Furthermore, the glass complex can be used as a separating partition between two spaces. Furthermore, its two glass faces are capable of protecting the textile web from any external aggressions that might cause it to be damaged. An illuminating glass complex of this kind may be obtained according to conventional methods for making a laminated glass with a stack of a plurality of glass sheets, films or resins.

In practice, the optical fibres arranged in a warp and/or a weft are woven with the binding yarns. In this way, the textile web has a natural strength, allowing easy manipulation so that it can in particular be installed in the glass complex, but also for various ancillary functions such as the connection of the optical fibres with a light source. Different weaving patterns can be used, and in particular the canvas weave which allows good light transmission to be provided in both normal directions of the fabric.

Thus, according to a first embodiment, at least one layer of the glass complex includes a glass sheet and a resin interleaved between the textile web and the glass sheet. In other words, the link between the textile web and the glass sheet is obtained using a resin.

According to a first assembly alternative, the textile web and the glass sheet can be placed at a constant distance by means of a plurality of spacers arranged at the periphery. The resin is then injected into the space defined between the textile web and the glass sheet.

According to a second assembly alternative the resin may be directly applied to the surface of the textile web, and then it is the glass sheet which comes into contact with the resin.

In practice, the resin can be formed out of a material chosen from the group that includes polyepoxides, polyurethanes, polyesters and acrylics. Polyesters are able to polymerize at ambient temperature or preferably by raising the temperature. Acrylics can be cross-linked using ultra-violet radiation without modifying their temperature.

According to a second embodiment, at least one layer of glass complex may include a glass sheet and a film interposed between the textile web and the glass sheet.

In this case, the film is used to provide the link between, on the one hand, the textile web, and, on the other hand, the glass sheet. Such an assembly is complex to achieve and, in order not to damage the textile, it is necessary to find a compromise between the parameters of temperature, duration and pressure used. Indeed, the pressure used in the method of assembly may vary between 1 and 20 bars and the temperature may be between 80 and 180° C. in particular. Such conditions are generally obtained using an autoclave, a vacuum bag, calenders or a press. A film of this kind is generally between 1 and 5 mm thick.

An assembly method of this kind is generally coupled with a “degassing” operation and allows the air interstice between the two opposite layers of linking intermediaries constituted by the resin or the film to be reduced to the minimum. The air contained in the complex is sucked up at the periphery at the free ends of the optical fibres. This assembly stage thus requires the use of a compressible support to protect these free ends from the heat and pressure applied to the complex. Moreover at this stage, the fibres must remain motionless and not overlap.

To advantage, the film may be formed out of a material chosen from the group that includes Ethylene Vinyl Acetate (EVA), Thermoplastic Polyurethanes (TPU) and Poly Vinyl Butyral (PVB).

According to one particular embodiment, the optical fibres may each be formed by a sheathed web of a fluorinated polymer.

The web of the optical fibres may be formed out of a material chosen from the group that includes poly methyl methylacrylate (PMMA) and polycarbonate (PC). The combination of optical fibres comprising a web made of polycarbonate (PC) with TPU assembled at 120° C., has given good results in terms of film shrinkage. Indeed, this combination means that few, or even no, bubbling effects are generated between the textile web and the film.

For other uses, the optical fibres may also be formed by glass fibres capable of transmitting and emitting light laterally.

In practice, the binding yarns may be formed out of a material chosen from among the group that includes natural, artificial or synthetic yarns or fibres. Thus, polyamide or polyester yarns in particular may be used as binding or core yams.

Furthermore, the textile web containing the optical fibres may be illuminated in various ways and in particular using localized sources such as light-emitting diodes.

Thus, according to one particular embodiment, the illuminating complex may include on at least one selvage a plurality of localized sources arranged opposite at least one optical fibre free end.

In other words, the localized sources may be arranged directly on the edges of the glass sheets forming the selvage of the illuminating complex.

According to a first alternative, the optical fibres may extend beyond the surface defined by the glass sheets and may be gathered together in bundles at the selvage of the illuminating complex. In this event, an area emission source may be used to illuminate a plurality of free ends of optical fibres. Furthermore, optical systems for collimating the light emitted by the area emission sources may be interposed between the localized source and the optical fibre bundle.

According to a second alternative, the complex may include, on at least one selvage, an area emission source arranged opposite a plurality of optical fibre free ends.

Indeed, along the illuminating structure, a fluorescent tube may be arranged so that a plurality of optical fibre free ends may be illuminated. A collimator optical system may also be interposed between the fluorescent tube and the free ends.

An illuminating complex of this kind may comprise ground glass surfaces that allow the diffusion potential of the textile web to be increased. Its forms may be plane or out-of-true, since the textile is able to adapt to the shape of the glass sheets with which it is assembled.

The complex may also be fully transparent when it is not illuminated. However, the light energy it emits may enable it to be made translucent or substantially opaque and allow an area located behind the device to be masked.

Nanocharges, invisible to the naked eye, may possibly be embedded in the glass sheets to improve the diffusion of the light emitted by the optical fibres.

### BRIEF DESCRIPTION OF THE FIGURES

The way in which the invention is implemented, and the advantages deriving therefrom, will emerge clearly from the description of the following embodiment, given by way of information but non-restrictively, supported by the appended figures, wherein:

FIG. 1 is a cross-section view of a glass complex, in accordance with the invention.

FIGS. 2 to 4 are front views of a glass complex associated with different light source alternatives arranged on the selvages thereof.

### DETAILED DESCRIPTION OF THE INVENTION

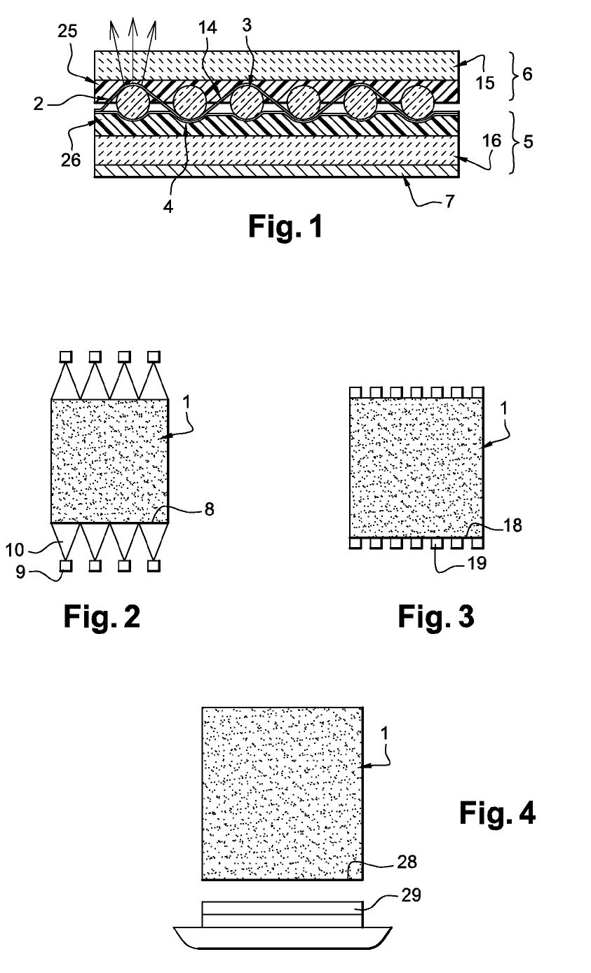

As already mentioned, the invention relates to an illuminating glass complex (1) which, as shown in FIG. 1, includes a textile web (2) embedded between two layers (5, 6) of the glass complex. Such a textile web (2) contains optical fibres (3) allowing the light to be transmitted laterally inside the two layers (5, 6) of the glass complex.

These optical fibres (3) are moreover associated, or even woven, with binding yarns (4, 14) which may be core yarns (4) from which binding yarns (14) periodically emerge to give a certain strength to the foundation textile web.

The layers (5, 6) of the glass complex may come in the form of a stack of a plurality of elements. As shown, the layer (5) may comprise a resin (25) in contact with the textile web (2) and a glass sheet (15) added to this resin (25).

The layer (6) may be similarly or differently constituted. This layer (6) may thus comprise a film (26) also brought into contact with the textile web (2), and a glass sheet (16) is then added to this film (26).

Furthermore, and in some special circumstances, it may be advantageous to add a final layer (7) to the surface of one of the glass sheets (16). A final layer of this kind (7) may in particular have a reflective, diffusing, antiglare, pollution fighting function, or the like.

For some uses, a glass complex of this kind may be almost transparent by using a textile web in which the binding yarns are polyamide yarns of a few tens of denier, typically 20 denier and number at most a few tens of yarns per centimetre, for example 30 yarns per centimetre.

The optical fibres may number about ten to the centimetre and be a few tens of millimetres in diameter. Indeed, the further apart the optical fibres are, the greater the transparency of the complex.

As shown in FIG. 2, a glass complex of this kind (1) may be associated with a plurality of localized light source (9) added to one of its selvages (8). Furthermore, the optical fibres may be gathered together into bundles (10), so as to engage a plurality of free ends opposite one and the same localized light source (9).

According to another embodiment as shown in FIG. 3, the localized light sources (19) may also be directly provided at the selvage (18) of the glass complex. In this way, the textile web may be sectioned at the selvage (18). An arrangement of this kind can be used to reduce the operations to make up and gather the optical fibres together into a bundle.

As shown in FIG. 4, the glass complex (1) may also be illuminated by means of an area emission light source (29), placed opposite one selvage (28). Such an area emission light source (29) may in particular be represented in the form of a fluorescent tube or a discharge tube incorporating a gas such as neon.

It is clear from what has been said above that an illuminating glass complex in accordance with the invention has manifold advantages, and in particular it makes it possible to implement a light on a surface without generating any unsightly marks on the complex to be manufactured in the glass structure; to implement diffuse and homogeneous illumination over the entire surface of the complex, and be completely invisible inside; it comprises excellent heat and flame resistance; its method of manufacture is fast.

1. An illuminating complex comprising two glass layers and a light source consisting of a textile web containing optical fibres arranged in a warp and/or weft associated with binding yarns in a warp and weft, said optical fibres being capable of emitting light laterally, wherein said textile web is embedded between the two layers.

2. The complex as claimed in claim 1, wherein the optical fibres arranged in a warp and/or weft are woven with the binding yarns.

3. The complex as claimed in claim 1, wherein at least one of the glass layers includes a glass sheet and a resin interposed between the textile web and said glass sheet.

4. The complex as claimed in claim 3, wherein the resin is formed out of a material chosen from the group consisting of polyepoxides, polyurethanes, polyesters and acrylics.

5. The complex as claimed in claim 1, wherein at least one of the glass layers includes a glass sheet and a film interposed between the textile web and said glass sheet.

6. The complex as claimed in claim 5, wherein the film is formed out of a material chosen from the group consisting of Ethylene Vinyl Acetate (EVA), Thermoplastic Polyurethanes (TPU) and Poly Vinyl Butyral (PVB).

7. The complex as claimed in claim 1, wherein the optical fibres are each formed by a sheathed web of a fluorinated polymer.

8. The complex as claimed in claim 7, wherein the web of the optical fibres is formed out of a material chosen from the group consisting of Poly Methyl Methacrylate (PMMA) and polycarbonate (PC).

9. The complex as claimed in claim 1, wherein the binding yarns are formed out of a material chosen from the group consisting of natural, artificial and synthetic yarns or fibres.

10. The complex as claimed in claim 1 further comprising, on at least one selvage, a plurality of localized sources arranged opposite at least one optical fibre free end.

11. The complex as claimed in claim 10, wherein the optical fibres are gathered together in bundles on said at least one selvage of the illuminating complex.

12. The complex as claimed in claim 1 further comprising, on at least one selvage, an area emission source arranged opposite a plurality of optical fibre free ends.
